(19) United States
(12) Patent Application Publication
(10) Pub. No.: US 2025/0328552 A1
(43) Pub. Date: Oct. 23, 2025

(54) MEMORY-EFFICIENT STRING DATA STORAGE FOR A DISTRIBUTED GRAPH-PROCESSING SYSTEM

(71) Applicant: Oracle International Corporation, Redwood Shores, CA (US)

(72) Inventors: Arnaud Delamare, Zurich (CH); Calin Iorgulescu, Zurich (CH); Irfan Bunjaku, Zurich (CH); Vasileios Trigonakis, Zurich (CH); Jinsu Lee, San Mateo, CA (US); Petr Koupy, Zurich (CH); Sungpack Hong, Palo Alto, CA (US)

(21) Appl. No.: 18/642,125

(22) Filed: Apr. 22, 2024

(51) Int. Cl. G06F 16/31

(52) U.S. Cl. CPC G06F 16/31

(57) ABSTRACT

A computer-implemented method includes obtaining graph data from a data storage device and storing in a memory string data based on the graph data; the string data includes strings of variable length, each having a unique string value. The method also includes creating a dictionary for the string data; the dictionary comprises a mapping between each string and a unique index. The method further includes storing the dictionary as a data structure separate from the string data. Each string is stored once at a memory location in the memory, and for each of the strings, the index for that string is stored at each instance of that string in the graph data. The index has a size according to a number of unique string values in the string data.

### FIELD OF THE INVENTION

The present invention relates to distributed graph processing, and more particularly to a system and method for string storage and processing for distributed in-memory graph systems.

### BACKGROUND

In a distributed graph-processing system, graph data is partitioned and distributed across multiple machines to support the vast scale of connected data while enabling the efficient execution of graph queries and graph algorithms.

Graph traversals (i.e., the core operation of any graph execution engine) exhibit random memory access patterns based on the edge relationships modeled. In particular, in distributed asynchronous traversals, depending on the query, the graph traversal operation might opt for a breadth-first (BFS) or a depth-first (DFS) approach, and sometimes will switch between the two during the execution of a single query. The non-sequential memory access patterns observed when accessing string properties of vertices and edges can lead to degraded compute performance. This is because data needs to be brought in and flushed out of the high-speed processor cache memory much more frequently, as locality is much more difficult to meet.

Asynchronous distributed graph execution systems employ early data materialization, which is required when work items are exchanged between machines. Each such materialized data item needs to be self-contained, with all the necessary information required to support filtering, ordering, and grouping operations. Multi-dimensional data (such as strings) need, therefore, to be stored in a format which is easy to serialize and transfer. Furthermore, work requests from other machines may arrive spontaneously and unpredictably change memory access patterns.

For example, the following simple query, expressed in Property Graph Query Language (PGQL):
SELECT a.name, b.name, COUNT (*)
FROM MATCH (a: Person)-[: friend]-> (x: Person)-> [: friend]-> (b: Person)
GROUP BY a.name, b.name
ORDER BY COUNT (*) DESC
   counts the number of common friends for any two persons. This “name” property is naturally a string, necessitating the carry-over of the string as the context moves from one vertex to the other; for example, carrying the a.name property over to matching of x and then moving to b, operations which might span different machines in a distributed system. Such operations call for strings that are easily indexed in arrays, have low overhead, and can be cheaply copied in the context and restored.

When a new machine is added to a distributed graph cluster, graph data must be rebalanced to include the new machine. Copying string entries one by one, and fixing pointers on the new machine, can be unacceptably expensive.

Importantly, partitioning and distributing graph data across multiple machines imposes strict constraints on how string data is stored in memory, and improving sequentiality of data accesses during traversal operations (e.g., by optimizing for the most commonly observed queries or algorithms) becomes infeasible. Work requests from other machines may arrive spontaneously and unpredictably change memory access patterns.

### BRIEF DESCRIPTION OF THE DRAWINGS

In the drawings:

FIG. 1 is a chart that describes various ways in which a string can be represented in memory, in accordance with embodiments of the disclosure.

FIG. 2 is a chart that shows the correlation between an index value type size and a number of unique values that are to be represented, in accordance with embodiments of the disclosure.

FIGS. 3A and 3B are connected flowcharts illustrating a procedure for building string dictionaries during distributed graph loading, in accordance with embodiments of the disclosure.

FIG. 4 schematically illustrates representation of small-sized graph-property string data, in accordance with additional embodiments of the disclosure.

FIG. 5 schematically illustrates representation of string data storage in a dynamically allocated memory region, in accordance with further embodiments of the disclosure.

FIG. 6A schematically illustrates a memory layout for dictionary-encoded graph property string data, in accordance with additional embodiments of the disclosure.

FIG. 6B schematically illustrates a memory layout for non-encoded graph property string data, in accordance with further embodiments of the disclosure.

FIG. 7 is a flowchart illustrating a procedure, in instances where strings are stored using external storage, for updating pointers that are stored in those strings, in accordance with embodiments of the disclosure.

FIGS. 8, 9 and 10 schematically illustrate a procedure in which strings stored in external regions using a bulk allocator are serialized and deserialized, in accordance with further embodiments of the disclosure.

FIG. 11 is a block diagram that illustrates a computer system upon which an embodiment of the invention may be implemented.

FIG. 12 is a block diagram of a software system that may be employed for controlling the operation of a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### 1. General Overview

In accordance with embodiments of the disclosure, there is provided a system for property graph-specific string storage, deduplication, and processing that is suitable for the complex workloads and context-rich natural-language graph data found in current distributed graph processing frameworks.

In various embodiments, there is provided a system for graph-property columnar offset-indexed string storage, including a storage layer where graph property strings are encoded for fast comparison/filtering operations and fast inter-machine shipping of string sets when rebalancing graph data across the cluster.

In additional embodiments, there is provided a system for graph-property columnar selective string deduplication, in which string data is deduplicated on a columnar level across all nodes, when considered necessary to improve memory locality and footprint.

### 2. Definitions

Specific terms as used herein include:
String: a sequence of 0 or more characters, without any specific encoding, and with no restrictions on allowed characters in the strings (apart from the NULL terminator).
Dictionary: a mapping between an index (an integer value) and a string.
Vertex/Edge property: a value representing a characteristic of one or more vertices or edges, which may be of different types. For instance, in a property graph representing people, common properties would include name, address, age, etc.

### 3. Graph-property String Data Representations

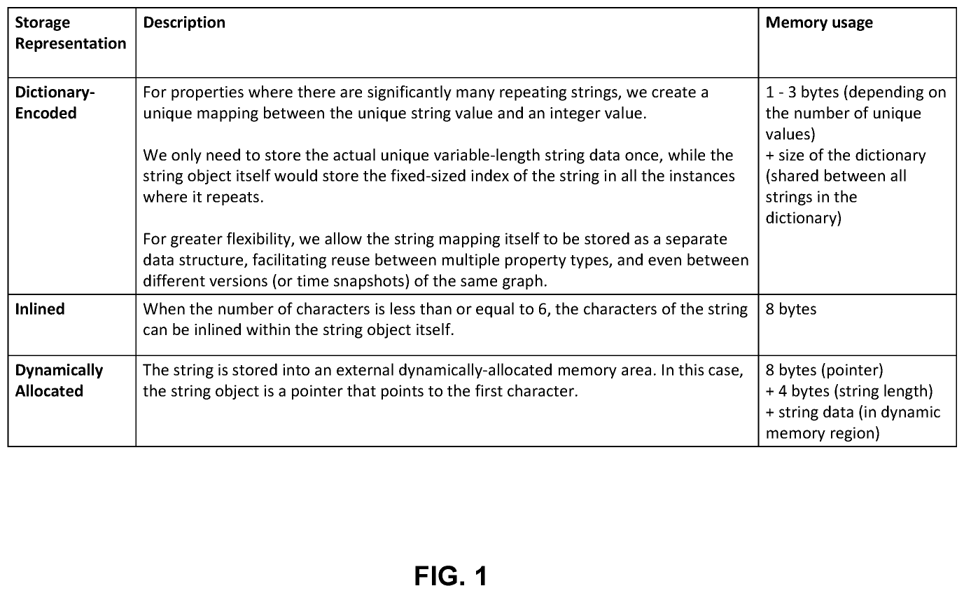

In one or more embodiments, a string can transparently be represented in various ways, including (1) dictionary-encoded storage; (2) inlined storage; (3) dynamically allocated storage in an external memory. An overview of these storage representations is presented in FIG. 1. In practice, strings are often small or highly repetitive. Using one of the approaches shown in FIG. 1 can significantly reduce the average amount of memory per string.

All of the above-noted storage representations implement a uniform access application program interface (API). In particular embodiments, the API includes the following features:
size( ) Returns the number of characters in the string (except for the NULL terminator)
char_at(index) Returns the character at the position index
c_str( ) Returns a pointer to a valid C string (a contiguous NULL-terminated memory region)

### 4. Dictionary-Encoded Graph-Property String Data

When strings are dictionary-encoded, their size depends on the number of unique values in the property that they encode. In various embodiments, each vertex or edge property is encoded independently; however, deduplicating further between similar properties is supported, which in turn requires additional semantic knowledge concerning these properties. For example, two or more properties representing peoples' names have a high chance of overlapping, but a property representing an address will most likely never overlap with a name property.

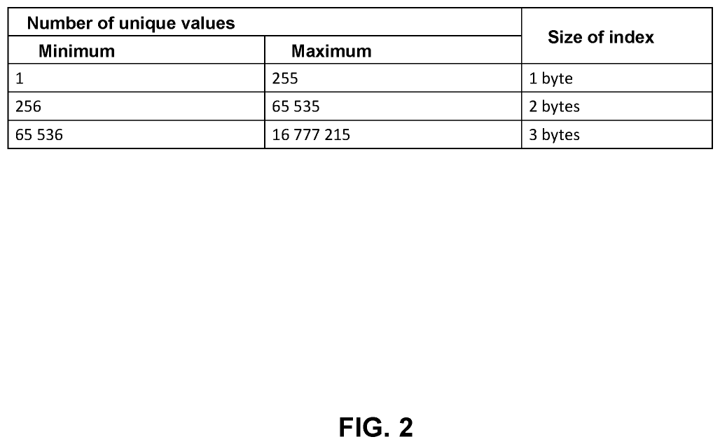

In an embodiment, the index value's type size is dynamically chosen based on the number of unique values to be represented. FIG. 2 shows the correlation in this embodiment between an index value type size and a number of unique values that are to be represented. The properties are stored as contiguous memory regions holding as many encoded string values as there are vertices/edges. The total number of bytes used depends on the number of unique values.

In a further embodiment, each dictionary-encoded property stores a two-way map between index and string, in addition to the per-string storage.

In a particular embodiment, the dictionary and the string's unique index can be used to access the memory location of the actual string value by means of a simple constant-time lookup. This typically has negligible performance overhead, while facilitating better locality and lower memory utilization. All API methods use the computed pointer to the start of the actual string value as they would for any non-encoded string.

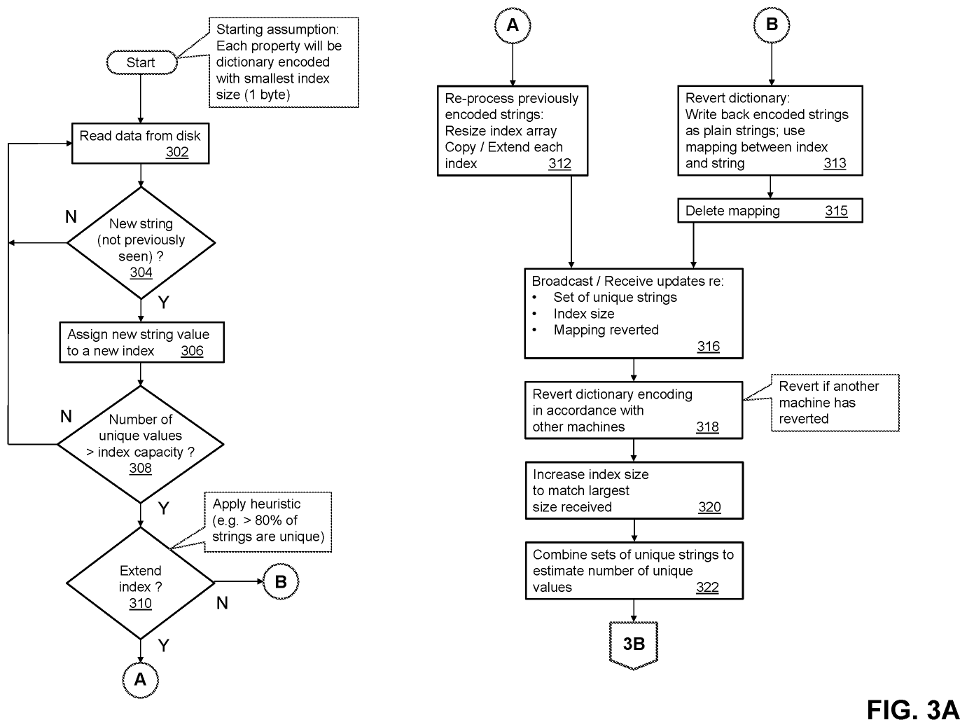

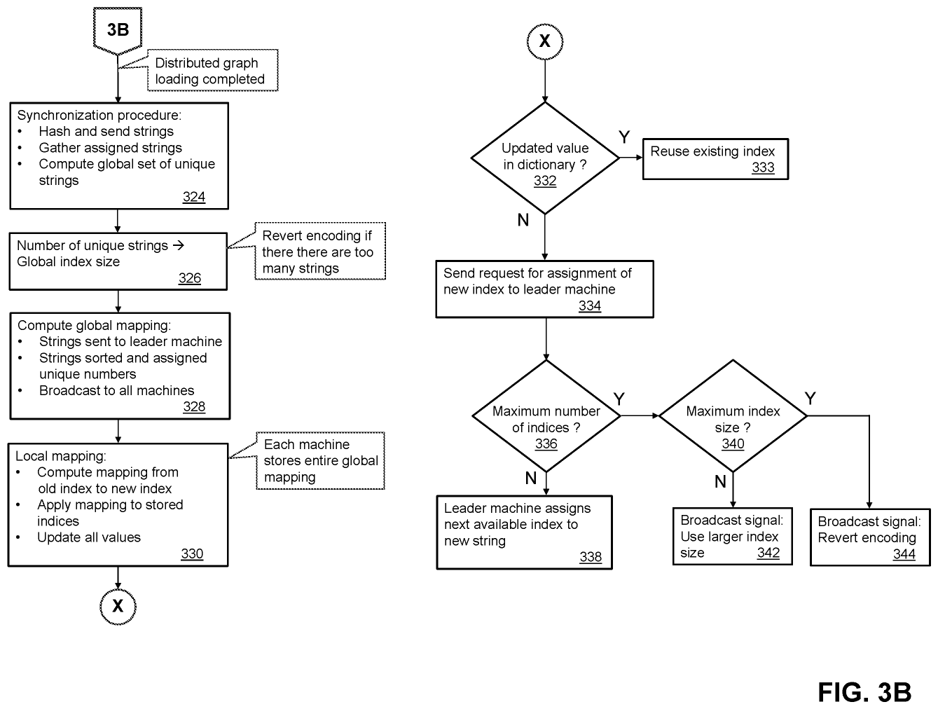

Dictionaries can be built automatically when the distributed graph is loaded. FIGS. 3A and 3B are connected flowcharts illustrating a procedure for building string dictionaries during distributed graph loading, in accordance with embodiments of the disclosure. In an embodiment, a set of machines are in communication with each other, and the set of machines includes a leader machine. When starting the loading procedure, it is assumed that each property will be dictionary encoded with the smallest index size (1 byte). Each machine reads the data from disk (step 302); when reading a new value for a string that it has not seen before (step 304/Y), will assign it to a new index (step 306).

If the number of unique values exceeds the capacity of the index's size (step 308), the machine will decide (step 310) whether to extend the index. This can be done using some heuristic: for example, if more than 80% of the strings are unique (i.e. an index was assigned for this string, but it has only been used once), then the dictionary encoding is reverted. Otherwise, the size of the index is increased.

To increase the size of the index (step 312), the machine re-processes every string that has been encoded previously. The array that stores the indices is also resized, and each index is copied and extended. If the dictionary is reverted (step 313), all of the strings are written back as plain strings (either inlined or with external storage, as detailed below) using the mapping between index and string; the mapping can then be deleted (step 315).

During the loading procedure, the machines will periodically broadcast updates regarding their set of unique strings, their index size, and whether they have reverted the mapping (step 316). When receiving an update, the machine will react accordingly: if another machine has reverted the dictionary encoding, it will revert also (step 318); it will increase its index size to match the largest index size that it has received (step 320); and it will combine the set of unique strings on other machines with its own (step 322) to have a more precise estimate of the number of unique values. The machine can revert the encoding if too many values have been seen.

After the loading procedure is complete, a synchronization procedure is performed (step 324). In this embodiment, the global set of unique strings is computed. Each machine will hash all of its strings and send each of them to the machine with ID=hash (string) %<number of machines>. Every machine will gather the strings assigned to it and the number of unique strings can then be computed globally. The final (and global) index size is chosen based on this number (step 326). If there are too many strings, the encoding is reverted.

A global mapping is then computed (step 328). Each machine sends its strings to the leader machine, which sorts them alphabetically and assigns them a unique number, which is then broadcast to all machines. When receiving the new mapping, each machine will compute a mapping from the old index to a new index, and apply this mapping to the indices that it has stored (this can be done very efficiently in parallel; in addition, this mapping from the old index to the new index can be stored as an array, which gives very fast lookup performance).

For example, if the machine has as local mapping {0″A″, 1″C″}, and receives from the leader machine the global mapping {0″A″, 1″B″, 2″C″}, then the machine will create a mapping from old index to new index that looks like this {00, 12}. Using this last mapping, the machine will iterate in parallel over all the values, and update them. In this embodiment, this remapping is done independently for each vertex/edge property.

In the case of a property update, if the updated value is already part of the dictionary (step 332), then the existing index is simply reused (step 333). Otherwise, if the value is new, a new index will need to be assigned. In this case, a request to assign a new index is sent to the leader machine (step 334), which assigns to the new string the next free index (step 338). In case there are not enough indices (step 336), the leader will broadcast a signal to either use a larger index size (step 342), or revert the encoding (step 344) in case the index size is already at the maximum (step 340).

Dictionary-encoded string property data can be effectively used in distributed graph queries. In an embodiment, dictionary-encoded strings are used in a PDQL query; the query is automatically rewritten to use the dictionary. In an example where the graph represents an online store catalog, a processing system (also referred to herein as an engine) may process the query
SELECT v.name WHERE v.type=‘TV’
   Assuming that v.type is a string property that is dictionary encoded, the engine fetches the encoded value of the string ‘TV’. If no such string is found, the query does not need to be run, and the engine will return an empty result. If there is a string ‘TV’ and the corresponding index is I, the query is then rewritten as
SELECT v.name WHERE v.type=‘I’ where v.type is now the dictionary index.
   It will be appreciated that use of dictionary-encoded strings can improve network performance. For example, with the query
SELECT w.name, v.name, v2.name
   MATCH (v: company)-> (w: product)<-(v2: company)
      WHERE v.country=v2.country
         the engine will fetch the companies from the same country that sell the same product. Without dictionary-encoded strings, in order to compare the countries of the two companies, it would be necessary to send the full string from the machine that owns v to the machine that owns v2. With dictionary-encoded strings, only the index within that dictionary needs to be sent; this can reduce network usage and improve performance. This scheme is feasible because the dictionaries are shared between machines.

In this and other embodiments, the dictionaries are limited to a given property. For example, the query
SELECT v.name WHERE v.type=v.name
   would not yield an optimized result, since v.type and v.name do not have the same dictionary.

Since the indices are sorted, lexicographical comparisons of strings can be performed on the indices directly. For example, the query
SELECT w.name, v2.name
   MATCH (v: company)-> (w)<-(v2: company)
      WHERE v.country<v2.country
         can be rewritten to access the ‘country’ property as an index directly, rather than as a string.

In accordance with the disclosure, string data is stored as dictionary-encoded strings unless the number of unique strings is too large (see FIGS. 1 and 2). Other storage representations (i.e., inlined string data and externally stored string data) are used when the number of unique strings is too large, so that dictionaries cannot be used. In these embodiments, dictionary-encoded strings are not mixed with inlined strings or strings using external storage.

### 5. Memory-Inlining of Small-Sized Graph-Property String Data

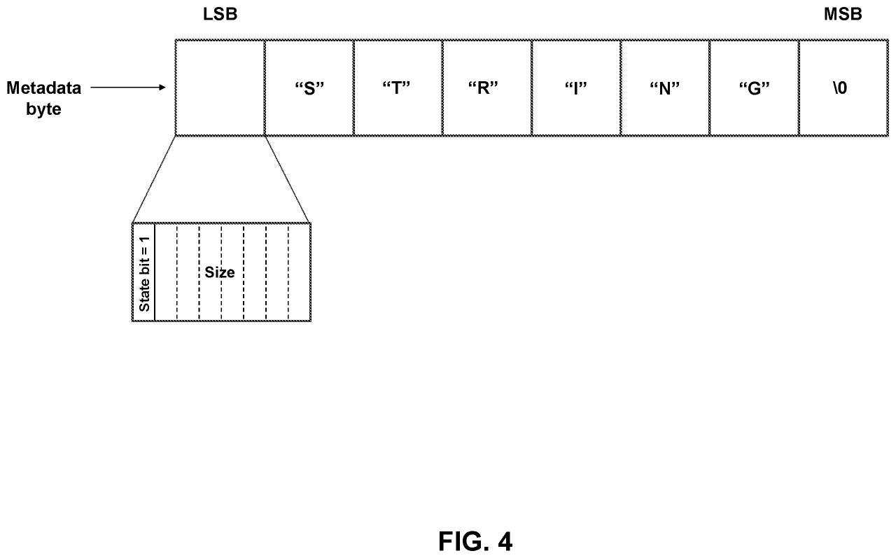

A memory-inlined string storage representation, according to various embodiments, can be highly efficient for small strings. As shown in FIG. 4, strings using this representation have a length of up to 6 characters and fit into 8 bytes; the first byte is used to store metadata for the string, and the last byte is a NULL terminator indicating the end of the string.

The metadata byte is used to store: (1) the state of the string (a single bit, set to 1 for inlined strings); (2) the size of the string, using the remaining 7 bits.

An internal API for memory-inlined graph-property string data can be implemented as follows:
size( ) The state byte is read and the size is extracted
char_at(index) The character at the given index (position in the 8-byte structure, omitting the metadata byte) is read
c_str( ) Returns a pointer to the first character in the 8-byte structure (omitting the metadata byte)

This storage representation can be used effectively in PGQL queries. Similarly to dictionary-encoded strings, when strings are stored using this representation, sending such strings over a network is more efficient that sending an external array of characters, since only 8 bytes are sent.

### 6. Dynamically Allocating Graph-Property String Data

If the number of unique strings is such that dictionaries cannot be used, and the string is too long so that inline representation cannot be used, then the string data can be stored in a dynamically allocated memory region. This type of storage representation is fully compatible with an inlined representation. In various embodiments, string properties can have mixed strings (i.e., some using external storage and some inlined); this is transparent to the engine.

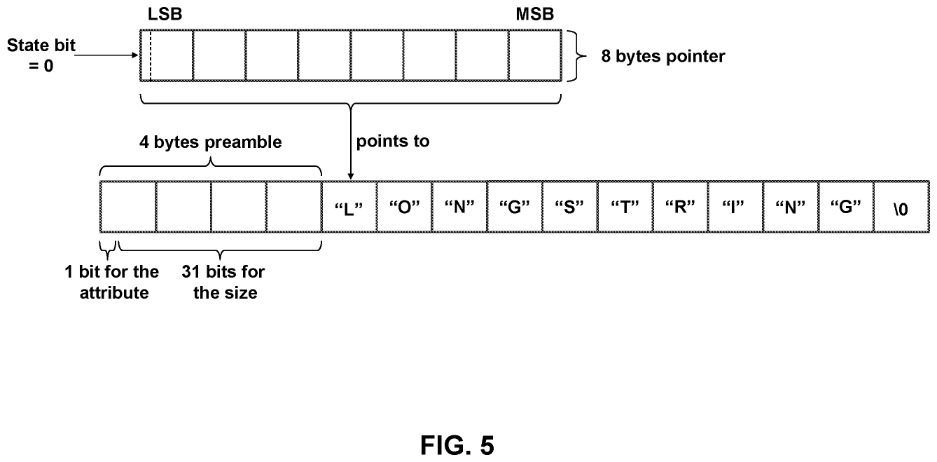

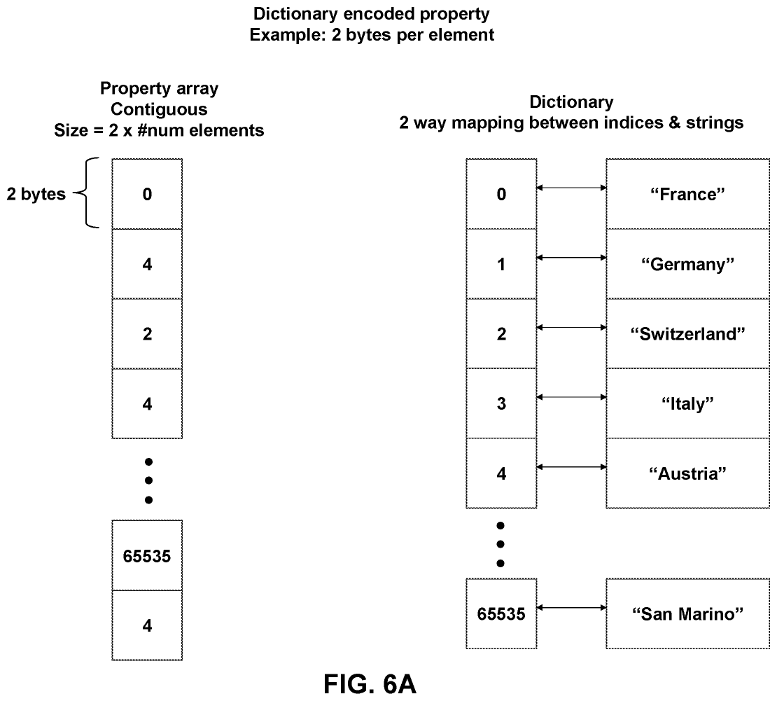

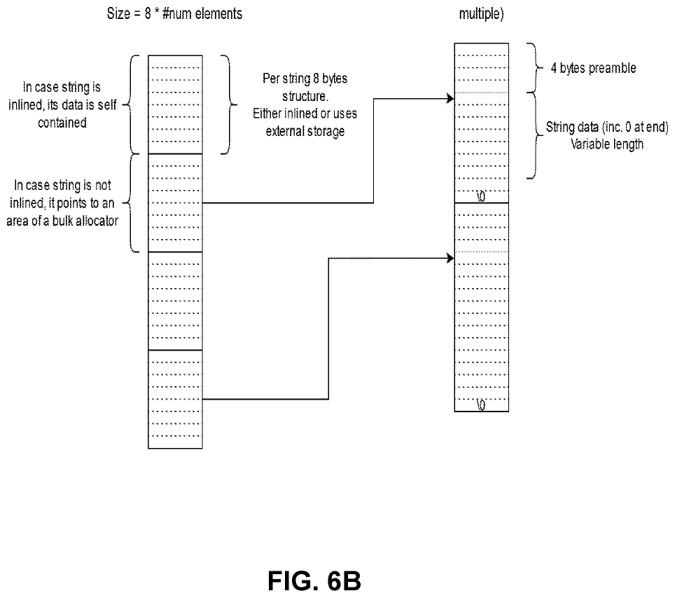

FIG. 5 schematically illustrates a memory layout of strings using this storage representation. Similarly to inlined strings, the main structure is formed from 8 contiguous bytes, and the Least Significant Bit (the state bit) is set to 0 (recall that when the string is inlined, it is set to 1). These 8 bytes thus form a fully valid pointer that points to the actual content of the string.

The memory pointed to by the pointer can be allocated in a variety of ways. For example, a basic allocator is provided in the C/C++ standard library. Such standard allocators have the advantage of simplicity, but have a memory overhead for every allocation (approximately 8 bytes per allocation). This increases significantly the memory used when allocating medium-sized strings (about 10 characters in length) that are very common in graphs.

In various embodiments, bulk allocators are supported; that is, a larger chunk of memory (e.g., several MB) is allocated for the data of several strings contiguously. The per-string allocation overhead is thus avoided, and the implementation of the string methods is the same as when the allocation is done per-string. Another issue to be addressed is properly deallocating the string data. When the string content is allocated individually, this can be done by deallocating the (not-shared) memory that was allocated specifically for the individual string. When bulk allocators are used, the string content of a single string cannot be deallocated individually, as the memory block from the bulk allocator is used for multiple strings. In this case, the entire bulk allocator is deallocated at once, when the entire property column is deleted. This can yield an improvement is performance, since many individual smaller deallocations (e.g., for each individual string) would require invoking the operating system's memory management layer significantly many more times.

As shown in FIG. 5, the 8-byte pointer points to the beginning of the string; however, additional metadata information is stored in the preamble. In this embodiment, the preamble includes one bit to describe whether the string is using a bulk allocator. This is important information for deallocation, as string content should not be deallocated if a bulk allocator is not used. The remaining 31 bits of the preamble are used to store the size (i.e., the number of characters without the NULL terminator) in the string content.

An internal API for memory-inlined graph-property string data can be implemented as follows:
size( ) The preamble byte is read and the size is extracted
char_at(index) Add index to the stored pointer, and return the character pointed to
c_str( ) Returns the pointer stored in the 8-byte structure

### 7. Graph-Data Inter-Machine Rebalancing

In distributed graph engines, rebalancing of data (i.e., transfer of data from a sending machine to a target machine) can occur frequently, so it is desirable that a rebalancing procedure be fast and inexpensive. In various embodiments, strings are dictionary-encoded; since the dictionary is shared between the machines, the only data that needs to be sent is the column having the dictionary indices. The data thus can be transmitted in batches, so that there is no need to update individual values.

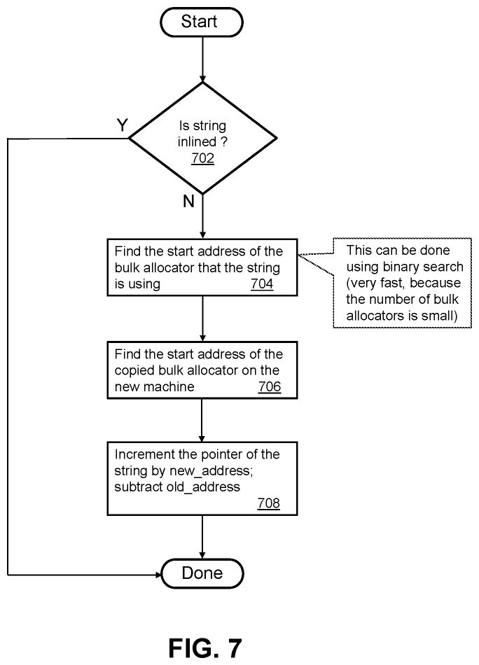

In other embodiments, strings are not dictionary-encoded. In this case, similarly to when strings are dictionary encoded, the property column (holding the 8 bytes structures) will be sent as is. The data of the bulk allocators will also be sent to the target machine. In both transfers, the data is sent in batches (as both the property column and the bulk allocators comprise single memory chunks), which is more efficient compared to sending many small memory regions. However, this is not enough for the rebalancing to be correct. Specifically, in case some strings are using external storage, the target machine will also need to update the pointers that the strings are storing. This can be done according to a procedure as shown in FIG. 7. If a string is inlined (rather than stored in external allocated memory), no updating is necessary (step 702). The target machine finds the start address of the bulk allocator that the string is using (step 704), and finds the start address of the copied bulk allocator on the new machine (step 706). In an embodiment, finding the starting address of the bulk allocator can be done using a binary search, which can be very fast since the number of bulk allocators is small. In step 708, the pointer of the string is incremented by new_address, and old_address is subtracted.

### 8. Transferring Graph-Property String Data

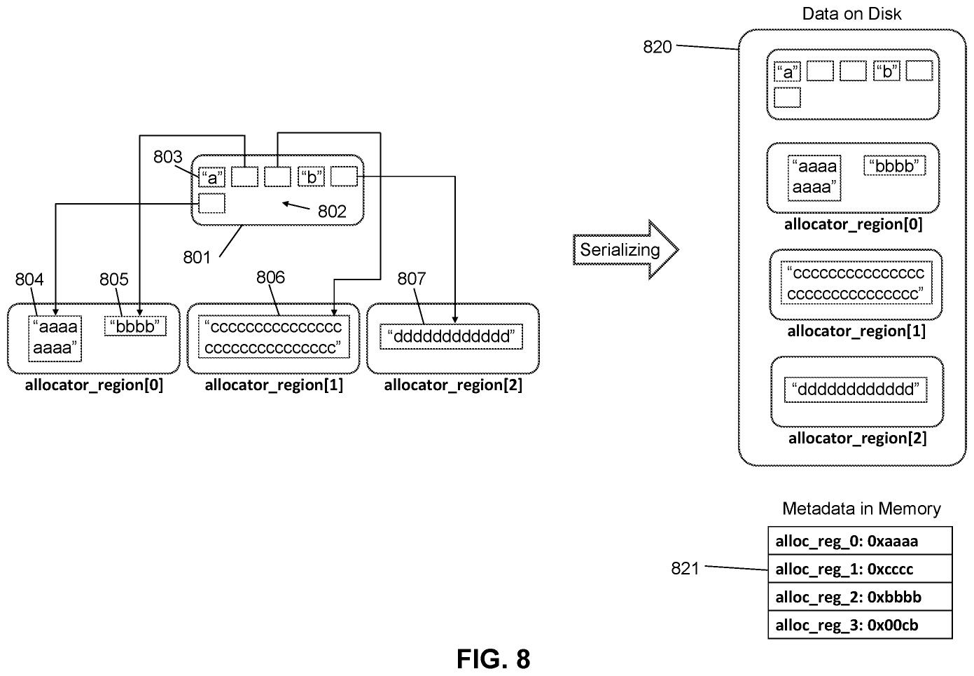

FIGS. 8, 9 and 10 schematically illustrate a procedure in which strings stored in external regions using a bulk allocator are serialized and deserialized, in accordance with further embodiments of the disclosure. Referring to FIG. 8, a data storage container 801 contains a number of strings 802 (e.g., array, vector, graph data array or similar). Some of these strings 803 are inlined, while others (e.g. strings 804, 805, 806, 807) are stored in external regions using a bulk allocator which allocates several allocator regions (in this example, regions [0], [1], [2]). When using a bulk allocator, there are no strings that have their own allocated external data. During the serialization of the strings the container 801 is dumped to external storage 820 as is, and all allocator regions are dumped into their own files without any modification. During the exporting of strings, the start pointer of each allocator region is saved (e.g., pointer 821 for allocator region [1]).

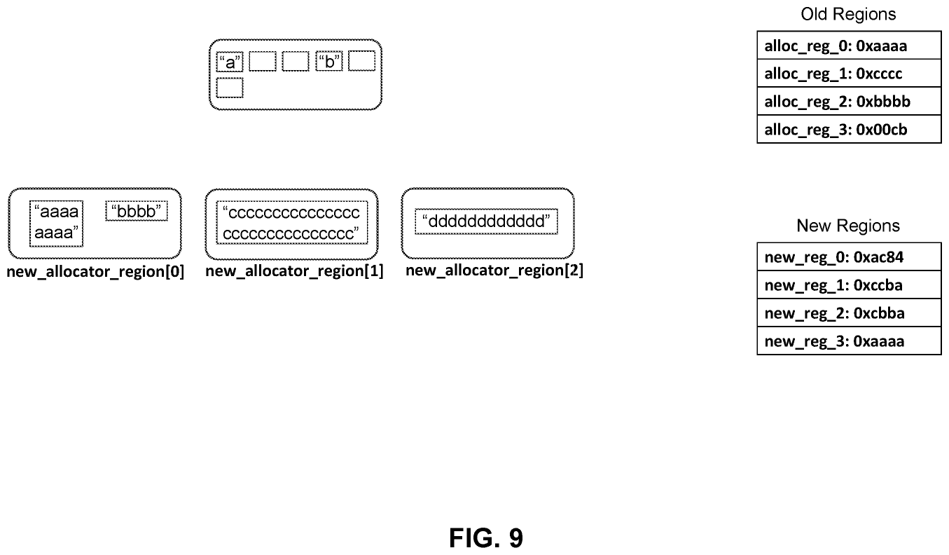

During graph loading, the container and all allocator regions are brought back into memory. As shown in FIG. 9, new regions (with potentially different addresses) of the same size are created and data is loaded into them. There is a one-to-one mapping between old memory regions and new memory regions.

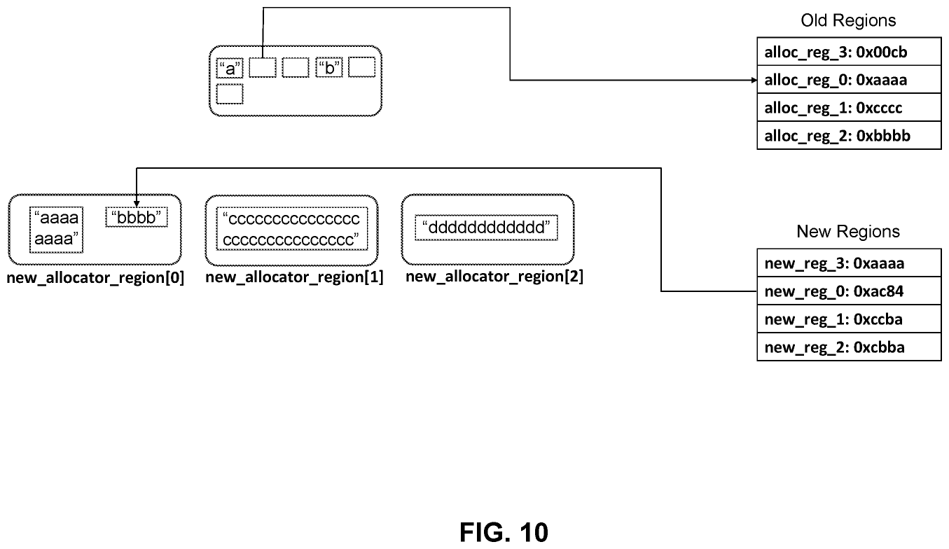

Referring to FIG. 10, memory regions are then sorted by the old allocator region base address. Then, each string is inspected. If it is inlined, it will be loaded as-is. Otherwise its (outdated and invalid) pointer will be read, and using a binary search on the previously saved start and end pointers of each allocator region, its new allocator region will be determined. The pointer for each string is then modified to point to the same offset in the same allocated region (which has been loaded into a new memory location).

It will be appreciated that the graph-property columnar string-data storage techniques described herein leverage simple strategies to facilitate fast random memory access (an important requirement for graph processing due to the random memory access patterns of graph queries). These techniques can also maximize useful memory utilization, minimize memory fragmentation, and leverage cache memory locality for performance. They thus facilitate high-performance distributed graph querying and matching operations on textual data, which are essential in modern distributed graph processing.

### 9. Hardware Overview

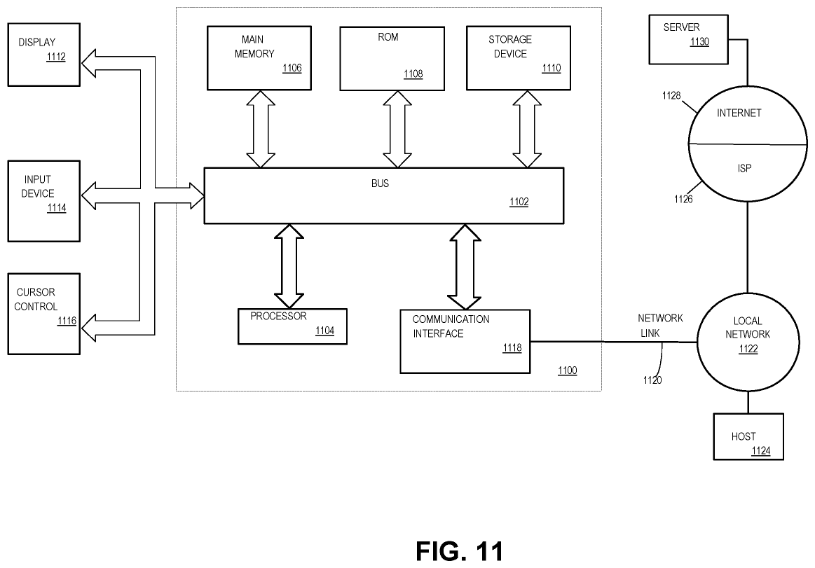

FIG. 11 is a block diagram that illustrates a computer system 1100 upon which an embodiment of the invention may be implemented. Computer system 1100 includes a bus 1102 or other communication mechanism for communicating information, and a processor 1104 coupled with bus 1102 for processing information. Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may be used for implementing one or more of the techniques described herein. According to one embodiment, those techniques are performed by computer system 1100 in response to processor 1104 executing one or more sequences of one or more instructions contained in main memory 1106. Such instructions may be read into main memory 1106 from another machine-readable medium, such as storage device 1110. Execution of the sequences of instructions contained in main memory 1106 causes processor 1104 to perform the process steps described herein. In alternative embodiments, hard-wired circuitry may be used in place of or in combination with software instructions. Thus, embodiments are not limited to any specific combination of hardware circuitry and software.

The term “machine-readable medium” as used herein refers to any medium that participates in providing data that causes a machine to operation in a specific fashion. In an embodiment implemented using computer system 1100, various machine-readable media are involved, for example, in providing instructions to processor 1104 for execution. Such a medium may take many forms, including but not limited to storage media and transmission media.

Storage media include both non-volatile media and volatile media. Non-volatile media includes, for example, optical or magnetic disks, such as storage device 1110. Volatile media includes dynamic memory, such as main memory 1106. Transmission media includes coaxial cables, copper wire and fiber optics, including the wires that comprise bus 1102. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1104 for execution. For example, the instructions may initially be carried on a magnetic disk of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128.

Local network 1122 and Internet 1128 both use electrical, electromagnetic or

optical signals that carry digital data streams. The signals through the various networks and the signals on network link 1120 and through communication interface 1118, which carry the digital data to and from computer system 1100, are exemplary forms of carrier waves transporting the information.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution. In this manner, computer system 1100 may obtain application code in the form of a carrier wave.

### 10. Software Overview

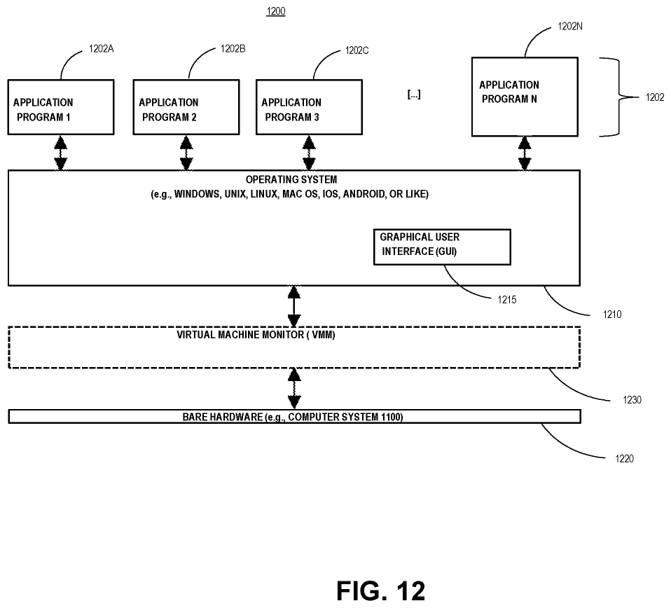

FIG. 12 is a block diagram of a software system 1200 that may be employed for controlling the operation of a computer system upon which an embodiment of the invention may be implemented. In particular, software system 1200 may be employed for controlling the operation of computing system 1100. Software system 1200 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1200, which may be stored in system memory (RAM) 1106 and on fixed storage (e.g., hard disk or flash memory) 1110, includes a kernel or operating system (OS) 1210. The OS 1210 manages low-level aspects of computer operation, including managing execution of processes, memory allocation, file input and output (I/O), and device I/O. One or more application programs, represented as 1202A, 1202B, 1202C . . . 1202N, may be “loaded” (e.g., transferred from fixed storage 1110 into memory 1106) for execution by the system 1200.

The applications or other software intended for use on computer system 1100 may also be stored as a set of downloadable computer-executable instructions, for example, for downloading and installation from an Internet location (e.g., a Web server, an app store, or other online service).

Software system 1200 includes a graphical user interface (GUI) 1215, for receiving user commands and data in a graphical (e.g., “point-and-click” or “touch gesture”) fashion. These inputs, in turn, may be acted upon by the system 1200 in accordance with instructions from operating system 1210 and/or application(s) 1202. The GUI 1215 also serves to display the results of operation from the OS 1210 and application(s) 1202, whereupon the user may supply additional inputs or terminate the session (e.g., log off).

OS 1210 can execute directly on the bare hardware 1220 (e.g., processor(s) 1104) of computer system 1100. Alternatively, a hypervisor or virtual machine monitor (VMM) 1230 may be interposed between the bare hardware 1220 and the OS 1210. In this configuration, VMM 1230 acts as a software “cushion” or virtualization layer between the OS 1210 and the bare hardware 1220 of the computer system 1100.

VMM 1230 instantiates and runs one or more virtual machine instances (“guest machines”). Each guest machine comprises a “guest” operating system, such as OS 1210, and one or more applications, such as application(s) 1202, designed to execute on the guest operating system. The VMM 1230 presents the guest operating systems with a virtual operating platform and manages the execution of the guest operating systems.

In some instances, the VMM 1230 may allow a guest operating system to run as if it is running on the bare hardware 1220 of computer system 1200 directly. In these instances, the same version of the guest operating system configured to execute on the bare hardware 1220 directly may also execute on VMM 1230 without modification or reconfiguration. In other words, VMM 1230 may provide full hardware and CPU virtualization to a guest operating system in some instances.

In other instances, a guest operating system may be specially designed or configured to execute on VMM 1230 for efficiency. In these instances, the guest operating system is “aware” that it executes on a virtual machine monitor. In other words, VMM 1230 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### 11. Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### 12. Extensions and Alternatives

One or more of the functions attributed to any process described herein, according to one or more embodiments, may be performed any other logical or physical entity, according to one or more embodiments. In various embodiments, each of the techniques and/or functionality described herein is performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
obtaining graph data from a data storage device;
selecting a storage representation for string data that is based on the graph data and comprises a plurality of strings of variable length, each of the plurality of strings having a unique string value, wherein the selected storage representation is one of a first storage representation or a second storage representation;
in accordance with a number of unique string values of the string data being not greater than a maximum number, storing the string data in a memory using the first storage representation, comprising
creating a dictionary for the string data, wherein the dictionary comprises a mapping between each string of the plurality of strings and a unique index; and
storing the dictionary as a data structure separate from the string data, wherein each of the plurality of strings is stored once at a respective memory location in the memory, wherein for each of the plurality of strings, the index for that string is stored at each instance of that string in the graph data; and
in accordance with the number of unique string values of the string data being greater than the maximum number, storing the string data in the memory using the second storage representation, comprising
storing a first plurality of string objects each having a size of a number of bytes and comprising a string of variable length having a maximum length of a number of characters less than the number of bytes and at least one metadata byte, and
storing a second plurality of string objects each having a size greater than the number of bytes in a dynamically allocated memory region and storing, in a memory separate from the dynamically allocated memory region, a plurality of pointers each pointing to a respective string object of the second plurality of string objects, wherein the pointer indicates a first character of a string content included in that string object, wherein at least one metadata byte included in that string object indicates an attribute of the string object and a size of the string content.

2. The computer-implemented method of claim 1, wherein the method is performed in a distributed graph processing system, wherein the graph data is partitioned across a plurality of computing machines each having associated therewith a portion of the plurality of strings, wherein each of the plurality of computing machines performs a hashing procedure for the portion of the plurality of strings associated therewith to generate a hashed string portion and sends the hashed string portion to a leader machine of the plurality of computing machines.

3. The computer-implemented method of claim 2, further comprising:
determining a set of unique strings in the plurality of strings;
determining a number of unique strings in the set of unique strings; and
determining a global index size based on the number of unique strings.

4. The computer-implemented method of claim 3, wherein the global index size is dynamically chosen based on the number of unique strings.

5. The computer-implemented method of claim 3, wherein the global index size is 1, 2, or 3 bytes.

6. The computer-implemented method of claim 5, wherein the index has an index size, and wherein the maximum number corresponds to a global index size of 3 bytes, and further comprising:
in accordance with the number of unique strings being greater than the maximum size, determining whether to increase the index size.

7. The computer-implemented method of claim 1, wherein the string data is stored in the memory by implementing an application programming interface (API).

8. The computer-implemented method of claim 1, wherein each of the first plurality of string objects and the second plurality of string objects includes a terminator byte.

9. The computer-implemented method of claim 1, wherein the dynamically allocated memory region is allocated using a bulk allocator.

10. The computer-implemented method of claim 9, wherein one bit of the at least one metadata byte of each of the second plurality of string objects indicates whether the string object is using a bulk allocator.

11. A non-transitory computer-readable medium comprising instructions executable by a processor to:
obtain graph data from a data storage device;
select a storage representation for string data that is based on the graph data and comprises a plurality of strings of variable length, each of the plurality of strings having a unique string value, wherein the selected storage representation is one of a first storage representation or a second storage representation;
in accordance with a number of unique string values of the string data being not greater than a maximum number, store the string data in a memory using the first storage representation, in a procedure comprising
creating a dictionary for the string data, wherein the dictionary comprises a mapping between each string of the plurality of strings and a unique index; and
storing the dictionary as a data structure separate from the string data, wherein each of the plurality of strings is stored once at a respective memory location in the memory, wherein for each of the plurality of strings, the index for that string is stored at each instance of that string in the graph data; and
in accordance with the number of unique string values of the string data being greater than the maximum number, store the string data in the memory using the second storage representation, in a procedure comprising
storing a first plurality of string objects each having a size of a number of bytes and comprising a string of variable length having a maximum length of a number of characters less than the number of bytes and at least one metadata byte, and
storing a second plurality of string objects each having a size greater than the number of bytes in a dynamically allocated memory region and storing, in a memory separate from the dynamically allocated memory region, a plurality of pointers each pointing to a respective string object of the second plurality of string objects, wherein the pointer indicates a first character of a string content included in that string object, wherein at least one metadata byte included in that string object indicates an attribute of the string object and a size of the string content.

12. The non-transitory computer-readable medium of claim 11, wherein the instructions are executable in a distributed graph processing system, wherein the graph data is partitioned across a plurality of computing machines each having associated therewith a portion of the plurality of strings, wherein each of the plurality of computing machines performs a hashing procedure for the portion of the plurality of strings associated therewith to generate a hashed string portion and sends the hashed string portion to a leader machine of the plurality of computing machines.

13. The non-transitory computer-readable medium of claim 12, further comprising instructions executable by the processor to:
determine a set of unique strings in the plurality of strings;
determine a number of unique strings in the set of unique strings; and
determine a global index size based on the number of unique strings.

14. The non-transitory computer-readable medium of claim 13, wherein the global index size is dynamically chosen based on the number of unique strings.

15. The non-transitory computer-readable medium of claim 13, wherein the global index size is 1, 2, or 3 bytes.

16. The non-transitory computer-readable medium of claim 15, wherein the index has an index size, and wherein the maximum number corresponds to a global index size of 3 bytes, and further comprising instructions executable by the processor to:
in accordance with the number of unique strings being greater than the maximum size, determine whether to increase the index size.

17. The non-transitory computer-readable medium of claim 11, wherein the string data is stored in the memory by implementing an application programming interface (API).

18. The non-transitory computer-readable medium of claim 11, wherein each of the first plurality of string objects and the second plurality of string objects includes a terminator byte.

19. The non-transitory computer-readable medium of claim 11, wherein the dynamically allocated memory region is allocated using a bulk allocator.

20. The non-transitory computer-readable medium of claim 19, wherein one bit of the at least one metadata byte of each of the second plurality of string objects indicates whether the string object is using a bulk allocator.
